(19) United States
(12) Patent Application Publication
(10) Pub. No.: US 2006/0149852 A1
(43) Pub. Date: Jul. 6, 2006

(54) Allocation of distribution weights to links in a packet network comprising traffic distribution

(76) Inventors: Gero Schollmeier, Gauting (DE); Christian Winkler, Munchen (DE)

Correspondence Address: Siemens Corporation;Intellectual Property Departement, 170 Wood Avenue South, Iselin, NJ, 08830, US

(21) Appl. No.: 10/543,601

(22) PCT Filed: Jan. 21, 2004
(86) PCT No.: PCT/EP04/00467

§ 371 Date: Jul. 28, 2005

(30) Foreign Application Priority Data
Jan. 28, 2003 (DE) 10303262.2

(51) Int. Cl. G06F 15/173

(52) U.S. Cl. 709/238

(57) ABSTRACT

The invention relates to a method for adjusting distribution weights in a network comprising multiway routing or distribution tiers. Traffic on links or via nodes in which a threshold value for the volume of traffic is exceeded is reduced by adjusting the relative distribution weights within the distribution tiers. The inventive method allows shifting of distribution weights so as to obtain equal traffic distribution in the network. Disclosed are abort criteria in case the volume of traffic exceeds the capacity of the network. Traffic distribution which respects load thresholds of individual links represents a major step towards guaranteeing quality of service characteristics for telecommunication services provided via the Net.

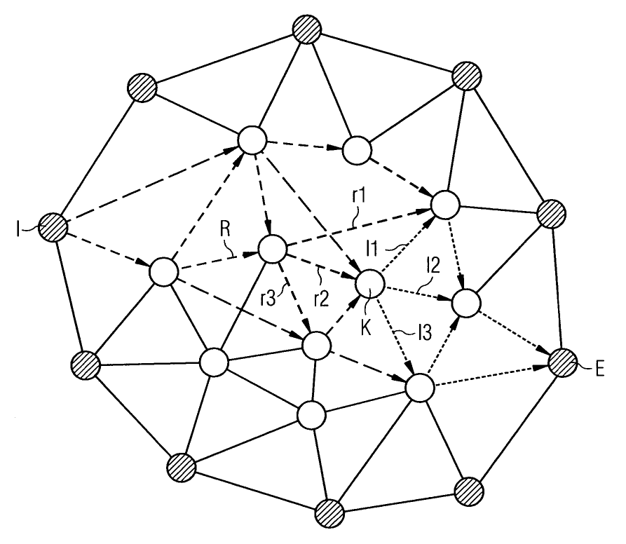

### CROSS REFERENCE TO RELATED APPLICATIONS

This application is the US National Stage of International Application No. PCT/EP2004/000467, filed Jan. 21, 2004 and claims the benefit thereof. The International Application claims the benefits of German application No. 10303262.2, filed Jan. 28, 2003, both applications are incorporated by reference herein in their entirety.

### FIELD OF INVENTION

The invention relates to the allocation of distribution weights to links in a packet network with traffic distribution.

### SUMMARY OF THE INVENTION

Perhaps the most important area of work for switching system engineers, network specialists and internet experts is currently the establishment of real-time data traffic via packet-oriented networks. It has to be possible to transmit voice data in particular—in this context often Voice over IP—but also video information in real time and with a high quality of service via packet networks, with IP networks having top priority. The high level of flexibility of the internet, which is essentially due to local routing decisions and “best effort” data transmission, is a handicap to the transmission of real-time traffic. In conventional IP networks, like the internet, there can be no guarantee of the quality of service of a data transmission because of the above characteristics. The delay times during data transmission are still generally too long for voice transmission. Also bottlenecks can occur, which are responsible for an uneven quality of service, which although tolerable for data transmission are not acceptable for voice transmission. Therefore IP networks are being developed, which will allow compliance with quality of service features.

An important approach to the transmission of real-time traffic via packet-based networks is the so-called DiffServ concept. In the context of this concept data packets entering a network are marked according to class of service at the edge of the network and handled according to said class of service when routed within the network. For the transmission of voice information, a corresponding class of service can be assigned, so that the associated data packets are prioritized when routed within the network. This method allows real-time traffic to be handled during routing, giving this high-priority traffic better quality of service characteristics than in conventional IP networks. The relative quality of service corresponding to classified traffic improves. Absolute quality of service features cannot be guaranteed however. A relative improvement of traffic classes is inadequate in respect of the absolute limits to be complied with, such as a maximum delay time for example during the transmission of voice information or a maximum loss rate during the transmission of video data.

A second important concept is the so-called MPLS (Multi Protocol Label Switching) method in which permanent connections are switched through a packet network. The MPLS method therefore allows bandwidth to be reserved for traffic with strict quality of service requirements. This advantage is however achieved at the cost of much of the flexibility of the conventional internet.

The object of the invention is to specify a method for improved routing through a packet network.

The object is achieved by the claims.

For a better understanding of the method according to the invention, a concept for ensuring quality of service transmission via packet networks, for which the method according to the invention can be deployed, is set out below. The concept is directed towards data transmission that complies with quality of service features via a packet network, without thereby surrendering too much of the inherent flexibility of conventional data networks. The concept is based inter alia on the following two points:

1. To avoid overload situations within a packet network, the overall volume of traffic is restricted by monitoring inward and outward traffic at the edge of the network and applying a restriction when a threshold value is exceeded.

2. Bottlenecks are avoided within the packet network by distributing the traffic within the network.

Restriction of the overall volume of traffic and the flexible distribution of traffic within the network allow the transmission of data traffic via the network to be controlled, allowing quality of service features—e.g. compliance with specific limits—to be guaranteed with a high level of probability, if the parameters are selected appropriately.

When distributing traffic, it is possible for example to consider the traffic transmitted through the network between pairs of ingress and egress nodes. Different routes are then available to this traffic, over which the traffic is distributed. As far as an ingress node is concerned, it is possible to consider the total number of links, via which data packets forwarded from the node can reach the egress node for each node in the network, via which traffic entering the network via the ingress node is transmitted. This total number of links relating to the node, going to the egress node and being a function of ingress and egress nodes is hereafter referred to as a distribution fan. The term link is used here as a logical term, assigned a physical connection between two nodes and one direction. Two links in opposite directions therefore correspond here to a physical link with duplex traffic calls according to the language used here.

The method according to the invention seeks to adjust distribution weights in a packet network made up of nodes and links. Traffic is thereby distributed in the packet network with the assistance of distribution fans. In a first method according to the invention to avoid overloading a network node, the entire traffic load from the node or to the node is determined and verified to ascertain whether the overall traffic load exceeds a threshold value. If the threshold value is exceeded, distribution weights at the links front-ending the node, which are associated with a distribution fan containing the node, are adjusted such that the traffic routed via the node is reduced. If for example a node front-ending the overloading node has three alternative outward links, which belong to the same distribution fan and lead to different nodes, the distribution weight of the two links that do not lead to the overloading node can be increased and the distribution weight of the link leading to the overloading node can be correspondingly reduced. This method can be implemented for all nodes in the packet network until the nodes are below the threshold value or an abort criterion is satisfied.

In a slight modification the method can be applied so as to reduce the load on a link in the packet network. The overall traffic load for the link is thereby determined and verified to ascertain whether the overall traffic load exceeds a threshold value. If the threshold value is exceeded, distribution weights of links, which are associated with a distribution fan containing the link, are adjusted such that the traffic routed via the link is reduced. For example the relevant link is one of three links associated with a distribution fan and going away from the same nodes. The distribution weight of the relevant link can then be reduced to the disadvantage of the other two links. Like the method for reducing the volume of traffic routed via a node the method can also be implemented for all the links in the data network until the volume drops below the threshold value for all links or an abort criterion is satisfied.

Generally the adjustment of distribution weights to reduce the load on a link or node can be terminated when the volume drops below the threshold value. The threshold value for a node is for example defined by the value of the bandwidth of all the links away from the node or to the node multiplied by a factor. For links the bandwidth of the link multiplied by a factor can be used as the threshold value. The factor is thereby between 0 and 1. In a preferred embodiment the factor is close to 1. Multiplying the bandwidth by a factor <1 ensures a reserve in the event of capacity utilization of the packet network. It cannot be anticipated that perfect traffic distribution will be achieved across the network, so that scheduled 100% utilization of the bandwidth may cause jams.

The traffic load via individual links or nodes can be determined using a traffic matrix. Such a traffic matrix can for example be based on the “worst case”, i.e. the maximum traffic load or can be determined dynamically or concurrently at regular intervals for readjustment of the distribution weights. Allocation of distribution weight in a network made up of many nodes in the link is a complex task. Calculation of the distribution weights based on the bandwidths of the links in the packet network and a traffic matrix generally results in a system of very many non-linear equations, which generally cannot be solved numerically with absolute precision. The method according to the invention represents a low-outlay, realistic method, which can be used to achieve distribution weights for an efficient traffic distribution within a packet network. With regard in particular to compliance with quality of service criteria by restricting the overall traffic volume and efficiently distributing traffic within the network, the methods according to the invention make an important contribution towards optimum distribution of traffic based on weight factors within the network.

In an advantageous development when reducing the traffic load in a link, this is achieved by reducing the traffic routed via the node front-ending the link according to the first method according to the invention. The reduction in the traffic load in the link via front-ending nodes is particularly expedient, if adjustment of the weights between links in the distribution fan has not resulted in a reduction to below the threshold value. The displacement and redistribution of distribution weights according to the invention shifts the traffic load in the network. If this shifting of the traffic load results in compliance with the criteria or the threshold value for every link or every node in the network, the method can be terminated. It is however also possible for the method not to converge or not to converge quickly, i.e. a value below the threshold value is not achieved for all links or nodes with an acceptable number of iterations. Different abort criteria can then be used. Abort criteria are as follows:

1. The number of nodes or links, in which the traffic load exceeds the threshold value, is not reduced with one or more passes over all the nodes or links in the network.

2. The sum of the squares of the difference between overall traffic load and threshold value added together over all the nodes or links, the traffic load of which exceeds the threshold value, is not reduced in one or more passes.

3. A maximum number of passes has been made, i.e. when the number of iterations reaches a predefined maximum value, the operation is aborted.

The methods according to the invention result in a rearrangement or adjustment of the distribution weights so as to achieve even traffic distribution. To be able to rearrange the distribution weights, the value of the distribution weights of nodes and links must first be initialized, i.e. initial values must be assigned. Expert allocation of initial values is important in respect of point convergence of the method, convergence referring to a value below the threshold value for all nodes or links. The distribution weights can for example be initialized by assigning initial values, with links associated with the same distribution fan and going away from or to a node being assigned a distribution weight according to their relative bandwidth for the node. This allocation of initial values can be further improved by making a relative adjustment to the distribution weights of a distribution fan according to the number of links within a distribution fan via which packets have to be transmitted from the links to a destination, so as to reduce the number of links. This improvement aims to reduce the distance within the network, along which traffic is routed in the packet network. It is clearly expedient within a distribution fan, which establishes the possible path alternatives for traffic associated with permanent ingress and egress nodes, to prefer the paths or routes, which pass through the fewest possible links. Reduction of the distance covered in the network leads to a reduction in the traffic volume in the network, with the overloading of individual links having to be avoided, which is ensured by the introduction of a threshold value.

It is also expedient to verify the overall load in the packet network as well, in order to select out beforehand situations in which the methods according to the invention do not converge for overall load. When verifying the overall load in the packet network, all the traffic entering the packet network via the edge node and leaving via said edge node is determined for example for each edge node in the network. This can for example also be done with the assistance of the traffic matrix. Then all the traffic entering or leaving via the edge node of the network is compared with the value of the bandwidth of all the links from the node or to the edge node multiplied by a factor. The factor is thereby a number between 0 and 1. The method is aborted if all the traffic entering or leaving via the edge node of the network exceeds the total bandwidth of the links from the edge node or to the edge node multiplied by the factor between 0 and 1. This allows situations to be avoided in which a traffic overload occurs at edge nodes, which could also result in an excessive overall volume of traffic within the network.

Direct verification of the overall traffic volume is achieved by a further development. A traffic matrix is thereby used to calculate the overall volume of traffic via all network links based on the initially assigned distribution weights and the method is aborted, if the overall volume exceeds the total bandwidth of the links in the packet network added together over all links and multiplied by the factor between 0 and 1.

In a preferred variant of the embodiment two outward links are provided for each internal node of the network.

The method according to the invention is described below in the context of an exemplary embodiment with reference to the FIGURE.

### BRIEF DESCRIPTION OF THE DRAWING

The sole FIGURE shows a network made up of nodes and links.

### DETAILED DESCRIPTION OF INVENTION

The FIGURE shows a network made up of nodes and links. Edge nodes are shown with shaded circles and internal nodes with empty circles. Links are represented by lines or arrows connecting nodes.

A distribution fan is shown for the ingress node I and the egress node E, which comprises the links shown with broken and dotted arrows. The distribution fan also includes the internal nodes R and K. A distribution fan is shown for the node K, containing the links shown with broken lines. The distribution fan comprises the outward links 11, 12 and 13 from the node K. The links r1, r2 and r3 go from the node R front-ending the node K. The following terms are introduced for the exemplary embodiment:
Hammock-sd: the number of all paths included in the multipath routing from an ingress node s of the network to an egress node d. A hammock-sd corresponds to a distribution fan between two edge nodes, e.g. the edge nodes I and E.
Fan-isd: Node i is part of the hammock-sd. Fan-isd is the path fan of the node i, which it has available in the destination direction (the section of the node i from the hammock-sd, comprising a plurality of egress links). For example the node K is part of the hammock-sd defined by the edge nodes I and E. The fan-isd for the node K then comprises the links 11, 12 and 13.
Reserve a: A link is only to be loaded to a-times (a<1) its bandwidth with traffic, to maintain a certain reserve. The network is therefore over-dimensioned for the purpose of overload protection.

The following initial assumptions apply for the exemplary embodiment:
There is traffic matrix for the network. It lists the respective traffic volumes between all the edge nodes of the network.
All multipath routes (hammocks) are defined and present.

It is proposed that the distribution weights be allocated to the individual links as follows:
1. It is verified for every edge node (e.g. edge nodes I and E) whether it can take the cumulative traffic coming to it and leaving it via its links. To this end the outward traffic from the traffic matrix is added up for the respective edge node and compared with a-times the sum of its outward link bandwidth. If it exceeds it, the network dimensions are too small and the method is terminated.
2. For the purposes of initialization the distribution weight W_{i,sd,k} is selected as proportional to the bandwidth of the respective link (standardized so that the sum of the distribution weights for fan-isd is one) for every hammock in the network at each node i in the hammock-sd for every link k of the fan-isd. For example distribution weights for the links 11, 12 and 13 are determined as proportional to their bandwidth.
3. With the weights determined provisionally according to step 1., the traffic load in each link is calculated on the basis of the traffic matrix (adding up the traffic elements of all the hammocks).
4. For a heuristic test on the adequate dimensioning of the network (for a specific routing) the traffic in all links thus calculated is added up and compared with a-times the sum of the bandwidths of all links. If it exceeds it, the network dimensions are too small and the method is terminated.
5. It is verified for every node of the network whether the sum of the traffic calculated according to step 3. exceeds a-times the sum of the-bandwidth of the egress links over all its egress links. For example the traffic via the links 11, 12 and 13 is added up for the node K. If this is the case, the node cannot take all the traffic allocated to it. The traffic must be distributed to other nodes in the network:
   For every such “overloaded” node the distribution weights at individual or all predecessor nodes for individual or all fans-isd containing links in the direction of the relevant node are gradually displaced (standardized so that the sum of the distribution weights for fan-isd is one), such that the load in the links in the direction of the relevant node is relieved to the extent that the condition specified under 5 is satisfied. Thus for example, if the node K is overloaded, the distribution weights of the egress links r1, r2 and t3 of the node R are adjusted. The weight of the link 12 (to the node K) is reduced, while the weights of the links 11 and 13 are correspondingly increased.
   Step 5 is repeated until either no further overloaded node is found or “insolubility” is determined according to an appropriate abort criterion. In the latter instance the method is terminated.
6. It is verified for every link in the network whether the traffic load calculated according to step 3. exceeds a-times its capacity. If this is the case, the link (taking into account the reserve) is overloaded and the traffic at this node must be redistributed to other links.
   For every such “overloaded” link at the node i the distribution weight is gradually reduced in individual or all fans-isd, which contain this link (standardized so that the sum of the distribution weights for fan-isd stays as one—therefore the weight at the other links in the fan is increased correspondingly), until the required reserve a is achieved. For example the relative weights of the links 11 and 13 are increased when the link 12 is overloaded.
   It is ensured during redistribution that the other links of the fan-isd do not for their part exceed the limit “a-times bandwidth” as a result of redistribution. Little utilized links are preferably selected to take traffic.
   Should it not be possible to achieve the required reserve for all links in this fashion, the level of traffic arriving at the relevant node is too high. In this instance (like step 5.) the distribution weights (e.g. r1, r2 and r3) in the predecessor nodes should be modified such that the volume of traffic from these predecessors via the relevant link is correspondingly reduced.
   With every pass through step 6. the node test is first carried out, as in step 5., for the node at which the link on which the load is to be reduced is present.

Redistribution of the traffic in previous passes could cause an overload at individual nodes, making step 6. insoluble in principle for this node. If this is the case for a node, it is handled according to step 5.
Step 6 is repeated until either no further overloaded link is found or “insolubility” is determined according to an appropriate abort criterion. In the latter instance the method is terminated.

Steps 5 and 6 are generally passed through several times before satisfactory network utilization is achieved. Abort criteria for the loops are inter alia:
If during a pass the number of links (or nodes in step 5) exceeding the value a (limit value for bandwidth utilization) over the entire network is not reduced and/or
If during a pass the square of the positive deviations from a is not reduced (i.e. the target value for network utilization is exceeded) and/or
   When a predefined number of passes has been achieved.

If the target values, i.e. fractions a of the bandwidth, are not achieved for all links or at least for a required proportion of said links, it is necessary to increase the bandwidth for one or more links.

The described method means that all links are generally evenly utilized and in particular have an identically sized relative reserve for peak loads (in relation to the respective link bandwidth), thereby allowing optimum traffic distribution.

Instead of the heuristic method proposed here to optimize network utilization other established optimization methods can also or alternatively be used, which generally require a greater computation outlay. Other criteria are also possible as target variables instead of even network utilization, e.g. defined concentration of the traffic on specific, e.g. particularly reliable, links or optimization of the permitted proportion of high priority traffic or cost minimization.

Possible Extensions:
Where practical in respect of computation outlay, optimization methods known per se such as the gradient method or variants thereof (e.g. Fletcher/Reeves, Fletcher/Powell) can also be used for subsequent optimization of the distribution weights.
When the weights are initially assigned, the number of hops required in the fan-isd via the respective link k to the destination can be taken into account, e.g. reduction of the weights in inverse proportion to the number of hops. This reduces the overall load in the network.
When the weights are initially distributed, traffic between adjacent nodes via a direct link can be assigned a higher value, to minimize higher network loading.

The method is not restricted to the sequence or combination of steps proposed in the exemplary embodiment.

1.-13. (canceled)

14. A method for adjusting distribution weights for a traffic distribution in a packet network to avoid overloading a node, wherein the packet network is made up of nodes and links, and wherein traffic distribution is effected in the packet network with the assistance of distribution fans, the method comprising:
determining an overall traffic load for outward links originating from the node or for inward links directed to the node;
verifying whether the overall traffic load in the outward or inward links exceeds a threshold value; and
adjusting distribution weights of links arranged upstream of the node and associated with a distribution fan containing the node if the threshold value is exceeded, such that traffic routed via the node is reduced.

15. The method according to claim 14, wherein for every node of the packet network:
the overall traffic load is determined for the links from the node or to the node,
it is verified whether the overall traffic load in the outward links or the inward links exceeds a threshold value,
distribution weights of links arranged upstream of the node, which are associated with a distribution fan containing the node, are adjusted such that the traffic routed via the node is reduced if the threshold value is exceeded,
until the volume is below the threshold value for all nodes in the packet network or an abort criterion is satisfied.

16. The method according to claim 14, wherein adjusting distribution weights is terminated when the volume is below the threshold value.

17. The method according to claim 14, wherein
the bandwidth of all the links from the node or to the node multiplied by a factor is used as the threshold value for a node, the factor representing a number between zero and one, and wherein
the bandwidth of the link multiplied by the factor is used as the threshold value for a link.

18. The method according to claim 15, wherein one of the following abort criteria is used:
a) the number of nodes or links, the traffic load of which exceeds the threshold value, does not drop taking into account all the nodes or links in the network after a plurality of iterations, or
b) the sum of the squares of the difference between the overall traffic load and the threshold value, added together over all the nodes and links, the traffic load of which exceeding the threshold value, does not drop after a plurality of iterations, or
c) a maximum number of iterations has been carried out.

19. The method according to claim 14, wherein at the start of the method initial values are allocated to the distribution weights, wherein the links from or to the node and associated with the same distribution fan being allocated distribution weights according to their relative bandwidth for the node.

20. The method according to claim 14, wherein during an allocation of initial values of the distribution weights to links, a relative adjustment of the distribution weight of a distribution fan is carried out according to the number of links within a distribution fan, via which packets have to be transmitted from the link to a destination, such that the number of links is reduced.

21. The method according to claim 14, wherein two outward links from the respective node are arranged at every internal node in the network.

22. A method for adjusting distribution weights for a traffic distribution in a packet network to avoid an overload in a link, the packet network being made up of nodes and links, and traffic being distributed with the assistance of distribution fans, the method comprising:
determining an overall traffic load for the link;
checking whether the overall traffic load exceeds a threshold value; and
adjusting distribution weights of such links associated with a distribution fan containing the link and leading away from the same node if the threshold value is exceeded, such that the traffic routed via the link is reduced.

23. The method according to claim 22, wherein adjusting distribution weights is terminated when the volume is below the threshold value.

24. The method according to claim 22, wherein
the bandwidth of all the links from the node or to the node multiplied by a factor is used as the threshold value for a node, the factor representing a number between zero and one, and wherein
the bandwidth of the link multiplied by the factor is used as the threshold value for a link.

25. The method according to claim 23, wherein, if a reduction in the overall traffic load to below the threshold value is not achieved, the traffic routed via the node arranged upstream of the link is reduced by the following method:
determining an overall traffic load for links going from the node or to the node;
verifying whether the overall traffic load in the outward or inward links exceeds a threshold value; and
adjusting distribution weights of links arranged upstream of the node and associated with a distribution fan containing the node if the threshold value is exceeded, such that the traffic routed via the node is reduced.

26. The method according to claim 22, wherein for every link in the packet network:
the overall traffic load is determined for the link,
it is verified whether the overall traffic load exceeds a threshold value, and,
if the threshold value is exceeded, distribution weights of links which are associated with a distribution fan containing the link are adjusted such that the traffic routed via the link is reduced,
until the volume is below the threshold value for all the links in the packet network or an abort criterion is satisfied.

27. The method according to claim 26, wherein one of the following abort criteria is used:
a) the number of nodes or links, the traffic load of which exceeds the threshold value, does not drop taking into account all the nodes or links in the network after a plurality of iterations, or
b) the sum of the squares of the difference between the overall traffic load and the threshold value, added together over all the nodes and links, the traffic load of which exceeding the threshold value, does not drop after a plurality of iterations, or
c) a maximum number of iterations has been carried out.

28. The method according to claim 22, wherein at the start of the method initial values are allocated to the distribution weights, the links from or to the node and associated with the same distribution fan being allocated distribution weights according to their relative bandwidth for the node.

29. The method according to claim 22, wherein during the allocation of initial values of the distribution weights to links, a relative adjustment of the distribution weight of a distribution fan is carried out according to the number of links within a distribution fan, via which packets have to be transmitted from the link to a destination, so as to reduce the number of links.

30. The method according to claim 22, wherein two outward links from the respective node are arranged at every internal node in the network.

31. A method for an overall load verification in a packet network, wherein the packet network is made up of nodes and links, the method comprising:
determining for every edge node in the network all the traffic entering and leaving the network via the edge node;
comparing all the traffic entering or leaving via the edge node with the value of a bandwidth of all the links from the edge node or to the edge node multiplied by a factor, said factor representing a number between zero and one; and
aborting the method if all the entering or leaving traffic exceeds the bandwidth.

32. The method according to claim 31, wherein
the total sum of the traffic via all network links is calculated with the assistance of a traffic matrix and the initially allocated distribution weights, and wherein
the method is aborted, if the total sum exceeds the total bandwidth of the links in the packet network added together over all network links and multiplied by the factor.

33. The method according to claim 31, wherein two outward links from the respective node are arranged at every internal node in the network.
